(19) United States
(12) Patent Application Publication
(10) Pub. No.: US 2011/0264601 A1
(43) Pub. Date: Oct. 27, 2011

(54) System and Method for Longevity/Mortality Derivatives Pricing and Risk Management

(76) Inventor: Yinglu Deng, Austin, TX (US)

(21) Appl. No.: 12/766,360

(22) Filed: Apr. 23, 2010

(51) Int. Cl. G06Q 40/00; G06N 5/02

(52) U.S. Cl. 705/36 R; 706/52

(57) ABSTRACT

A computer-implemented method and system which can be used for assessing and quantifying the longevity (mortality) risk and pricing the longevity (mortality) derivatives by using Asymmetric Jump Diffusion (AJD) Model is disclosed. Longevity risk (Mortality risk), which is defined as the uncertainty associated with the overestimation (underestimation) of the mortality rate, is faced by annuity providers, pension funds and life insurers. The AJD method and system, composed of means, introduce an appropriate probability density function at higher accuracy to capturing the leptokurtosis feature and the asymmetric jump feature of the mortality rate risk. The method and system include means for decomposing the mortality rate, means for capturing the time-specific indicator trend feature; means for calibrating the AJD model by Maximum Likelihood Estimation (MLE) procedure, means for projecting future mortality rate by Monte-Carlo simulation and means for pricing the derivatives with implied market price of risk.

### BACKGROUND OF THE INVENTION

The present invention is in the field of pricing and risk analysis. More particularly, the present invention relates to computer-implemented method and system which can be used for assessing and quantifying the longevity (mortality) risk and pricing the longevity (mortality) derivatives by using Asymmetric Jump Diffusion (AJD) Model.

The terms “Longevity Risk” and “Mortality Risk” have attracted the attention of the insurance industry, the pension fund industry and the securitization industry. Longevity risk (Mortality risk), which is defined as the uncertainty associated with the overestimation (underestimation) of the mortality rate. Longevity risk describes the risk that an individual, or group of individuals, will live longer than expected, while mortality risk is generally used to describe the risk that an individual, or group of individuals, will live, in aggregate, shorter than expected (i.e., their mortality will be higher than expected).

Dramatic improvements in longevity during the 20th century have shown the inadequate management of longevity risk by pension funds. The underestimation of longevity risk would cause more hundreds of billions aggregate deficit. In the US, the Internal Revenue Service (IRS) has recently established new mortality assumption for pension contribution, which according to Watson Wyatt will increase pension liabilities by 5-10%. Similarly, Mercer Human Resource Consulting has calculated that the use of up-to-date mortality tables would increase the cost of providing a pension to a male born in 1950 by 8%.

On the other side of the risk, many life insurers globally have become concerned about their exposure to catastrophic mortality risk. For example, during the 1918 flu, more than 675,000 excess deaths from the flu occurred between September 1918 and April 1919 in the United States alone, causing a huge jump on the mortality rate trend. More recently, H5N1 avian influenza occurred in Hong Kong in 1997, and H1N1 occurred globally in 2009. There is a possibility that a major pandemic event could trigger insolvency in the life insurance industry, and worsen if occurrence of catastrophe mortality events coincide with financial downturns.

In the securitization industry, the appearance of Insurance Linked Securities (ILS), facilitates the interaction and combination of the insurance industry and the capital market. Securitization provides the possible approach to load off the non-diversified risk from the insurer or pension balance sheet and transfer it to a capital market. This is a more efficient way to allocate and diversify risk in a much larger pool, constituted by the national or international capital market, and also enhances the risk capacity of the insurance industry, as illustrated by the CAT Mortality Bond and its derivatives, whose payment depends on the underlying loss indices and the catastrophe mortality event. On the insurance policy holder side, recently, many investment banks were involved in the life-settlement securitization. The investment banks purchase hundreds of thousands of the life insurance policies and repackage them into bonds, then sell them to investors such as pension funds. The payment of the bond depends on the life expectancy of the members in the pool.

The pricing of the CAT or life-settlement securitization depends on the estimation and forecast of life expectancy, which considers the longevity risk and mortality risk. The estimation and forecast of life expectancy also plays the crucial role in longevity/mortality risk management for pension or insurer. An Asymmetric Jump Model method and system in this invention is implemented to assess and quantify the longevity and mortality risk.

The model in the method and system describes the mortality rate's main trend and considers the cohort effect, capturing the age-specific adjustment for different age groups. The adjustment is critical for the model, since the mortality improvement and extreme positive or negative event (such as the influenza pandemic) has different effects for different age groups. Longevity jump and mortality jump should be considered in modeling and securitization, since these jumps are the critical sources of risk, so pension funds and insurers should be more cognizant of them. The mortality jump (such as the 1918 flu) has a short-term intensified effect, while the longevity jump (caused by the pharmaceutical or medical innovation) has long-term gentle effect. Considering the asymmetric jump phenomenon of mortality rate, the invention adopts a compound poisson-Double Exponential Jump Diffusion (AJD) model to capturing longevity jump and mortality jump, respectively.

The benefit and advantage of the model in the method and system include: 1) The model considers the cohort effect, describes the mortality indicator trend and adjusts the mortality indicator trend for different age groups. 2) The model applies the double exponential jump diffusion which can differentiate the longevity jumps and mortality jumps, in order to capture the skewness of the mortality indicator trend and fit the trend better. 3) The model has less parameters and more concise specification, which benefits the calibration and application for securitization pricing.

### BRIEF SUMMARY OF THE INVENTION

The AJD computer-implemented method and system is composed by 5 function units: 1. Decomposition Unit, 2. Differentiation Unit, 3. Calibration Unit, 4. Simulation and Projection Unit, 5. Calculator Unit. The method and system are implemented via programmed instructions embodied on computer-readable medium and network.

In the first step, the mortality rate data with respect to time and age group is input into the Decomposition unit via programmed instructions. The Decomposition unit applies the SVD procedure to separate the mortality indicator and age-specific factors in the mortality rate. The first stage in SVD procedure is to normalize the condition to generate the age-specific factors and mortality indicator which indicates the mortality trend. The second stage in SVD procedure is to re-estimate indicator of the mortality trend, given the estimation of age-specific factors in the first step, enables that the actual sum of death at time t equals the implied sum of deaths at time t. Through the first step, the Decomposition unit generates the decreasing mortality trend indicator as the input for the next Differentiation Unit.

In the second step, the Differentiation Unit, the computer-implemented program executes the differentiation calculation on the data of the decreasing time-specific indicator which is generated by the first step. Through the calculation, the Unit generates the increment of the mortality trend among time scale. In this way, the Asymmetric Jump Model is applied to capturing the mortality indicator trend, which is composed of a baseline Brownian motion stochastic process and a compound Poisson double-exponential jump diffusion process.

In the third step, the Calibration Unit, the computer-implemented program executes the model calibration based on the Asymmetric Jump Model specification, with the input data of mortality trend increment. The means for maximum likelihood calibration method with a closed-form density function can generate right parameters of low frequency and large size for jumps. The means for the calibration method has the advantage in disentangling jumps from diffusion. The double-exponential jump diffusion is a linear process with independent increments and an explicit transition density, which satisfies the requirement of a complete specification of the transition density for using maximum likelihood estimation. The program of calibration unit produces the calibrated parameters {λ, p; η₁, η₂; α, σ}.

In the fourth step, the Projection and Simulation Unit, the computer-implemented program simulates the paths of mortality trend, projects and forecasts the future mortality rate with the parameters generated by the Calibration Unit. Based on the projected mortality rate and the derivatives structure, the pricing engine calculates the price of the derivatives with the assumed implied market price of risk. Repeat the pricing procedure with approximating implied market price of risk until the calculated derivatives price equals the actual deal price. The means for the algorithm produces the implied market price of risk.

In the fifth step, the Calculator Unit, with the input of the AJD model parameters from Calibration Unit and implied market price of risk from Projection and Simulation Unit, produces the price of derivatives based on the AJD model. The derivatives include longevity bond, mortality bond, q-forward, the mortality swaps, etc.

### BRIEF DESCRIPTION OF THE DRAWINGS

FIG. 1 is a flow diagram depicting a network diagram of an embodiment of devices capable of assessing and quantifying the longevity risk and mortality risk exposure, and pricing the longevity derivatives using the asymmetric jump diffusion model.

FIG. 2 is a flow diagram depicting the main flow chart, corresponding to FIG. 1, of the whole computer-implemented method and system for assessing and quantifying the longevity risk and mortality risk exposure, and pricing the longevity derivatives using the asymmetric jump diffusion model. 5 Storages, 5 Processors, 4 Inputs and 1 Outputs are included.

FIG. 3A is a flow diagram depicting the detailed flow chart of composition and procedure of Unit 1, including Processor 410, and connection with Storage 310, Storage 320, Storage 321.

FIG. 3B is a flow diagram depicting the detailed flow chart of composition and procedure of Unit 3, including Processor 430, and connection with storage 330, storage 331, storage 340.

FIG. 3C is a flow diagram depicting the detailed flow chart of composition and procedure of Unit 4, including Processor 440, and connection with storage 340, storage 341, storage 350, storage 351.

FIG. 4A is a graph showing the historical mortality rate sample for 1900-2004 U.S. population, generated by Unit 1.

FIG. 4B is a graph showing the comparison of age group mortality rates, generated by Unit 1.

FIG. 5 is a table illustrating the age-specific factors generated in Unit 1.

FIG. 6 is a graph showing the time-specific factor, or the mortality trend indicator generated in Unit 1.

FIG. 7A is a graph showing the histogram of distribution of the mortality trend increment generated in Unit 2, in comparison with the projected increment by model without jumps.

FIG. 7B is a graph showing the histogram of distribution of the mortality trend increment generated in Unit 2, in comparison with the projected increment by model simulation in Unit 4.

FIG. 8 is a table illustrating the comparison of the fitness of the calibrated AJD model in Unit 3 and model without jump, model with normal jump.

FIG. 9A is a table illustrating the implied market prices of risk by Wang transform method, generated in Unit 4.

FIG. 9B is a table illustrating the implied market prices of risk by risk-neutral method, generated in Unit 4.

FIG. 10 is a table illustrating the derivative pricing result with the example of q-forward, generated in Unit 5.

### DETAILED DESCRIPTION OF THE INVENTION

The following is a detailed description of embodiments of the invention depicted in the accompanying drawings. The embodiments are in such detail as to clearly communicate the invention. However, the amount of detail offered is not intended to limit the anticipated variations of embodiments; but on the contrary, the intention is to cover all modifications, equivalents, and alternatives falling within the spirit and scope of the present invention as defined by the appended claims. The detailed descriptions below are designed to make such embodiments obvious to a person of ordinary skill in the art.

Turning now to the FIGURES which illustrate exemplary embodiments, a computer-implemented method and computerized system are shown which may be used to assessing and quantifying the longevity (mortality) risk, and pricing the longevity (mortality) derivatives by applying Asymmetric Jump Diffusion Model (AJD).

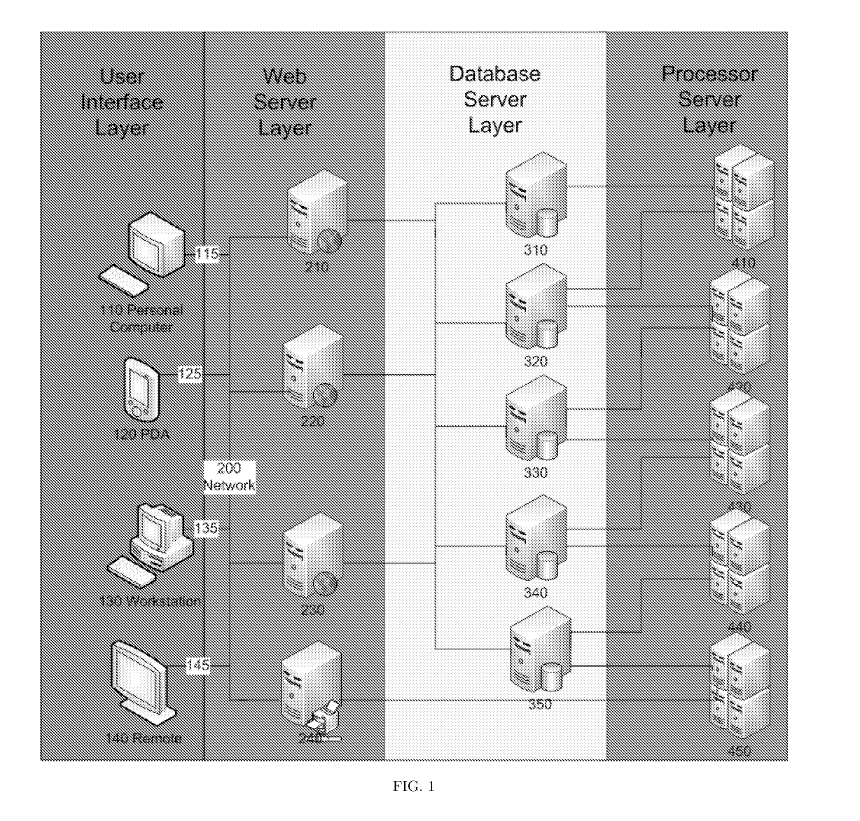

FIG. 1 depicts network diagram of an embodiment of devices capable of assessing and quantifying the longevity risk and mortality risk exposure, and pricing the longevity derivatives using the asymmetric jump diffusion model. The network includes 4 layers: User Interface Layer, Web Server Layer, Database Server Layer and Processor Server Layer.

The AJD system includes 4 layers: User Interface Layer, Web Server Layer, Database Server Layer, Processor Server Layer. The User Interface includes the manually data input receivers: a personal computer 110, coupled to network 200 through wireline connection 115; a personal digital assistant (PDA) 120, coupled to network 200 through wireless connection 125; a workstation 130, coupled to network 200 through wireline 135; a remote 140, coupled to network through wireline 145. The Web Server Layer includes the web import receivers 210, 220, 230 and output device server 240, 210, 220, 230, 240 are connected to the network 200. Network 200, which may consist of the Internet or another wide area network, a local area network, or a combination of networks, may provide data communication among the Database Server Layer and Processor Server Layer. Database Server Layer includes the database server 310, 320, 330, 340 and 350. Processor Server Layer includes the processor server 410, 420, 430, 440 and 450. The database server 310 includes the storage 310, which is directly connected to processor server 410. The database server 320 includes the storages 320 and 321, which are directly connected to processor server 410 and 420. The database server 330 includes the storages 330 and 331, which are directly connected to processor 420 and 430. The database server 340 includes the storages 340 and 341, which are directly connected to processor 430 and 440. The database server 350 includes the storages 350, 351 and 352, which are directly connected to processor 440 and 450.

Processors 410, 420, 430, 440, 450 for assessing and quantifying the risk, include random access memory (RAM), CPU, non-volatile memory, communications adapter, and Input/Output (I/O) interface adapter connected to network 200. Operating system on the processors may comprise UNIX™, Linux™, Microsoft Windows™, AIX™, IBM's i5/OS™, or other operating systems.

AJD risk assessing and quantifying systems in some embodiments of the present invention may omit a server. In some embodiments, software on an processor may assess and quantify without communicating with a server. In alternative embodiments, hardware may perform determinations to determine the price. Similarly, AJD systems in a few embodiments of the present invention may include additional servers, routers, other devices, and peer-to-peer architectures, not shown in FIG. 1, as will occur to those of skill in the art. Networks in such processing systems may support many data communications protocols, including for example TCP (Transmission Control Protocol), HTTP (HyperText Transfer Protocol), WAP (Wireless Access Protocol), HDTP (Hand-held Device Transport Protocol), and others as will occur to those of skill in the art. Various embodiments of the present invention may be implemented on a variety of hardware platforms in addition to those illustrated in FIG. 1.

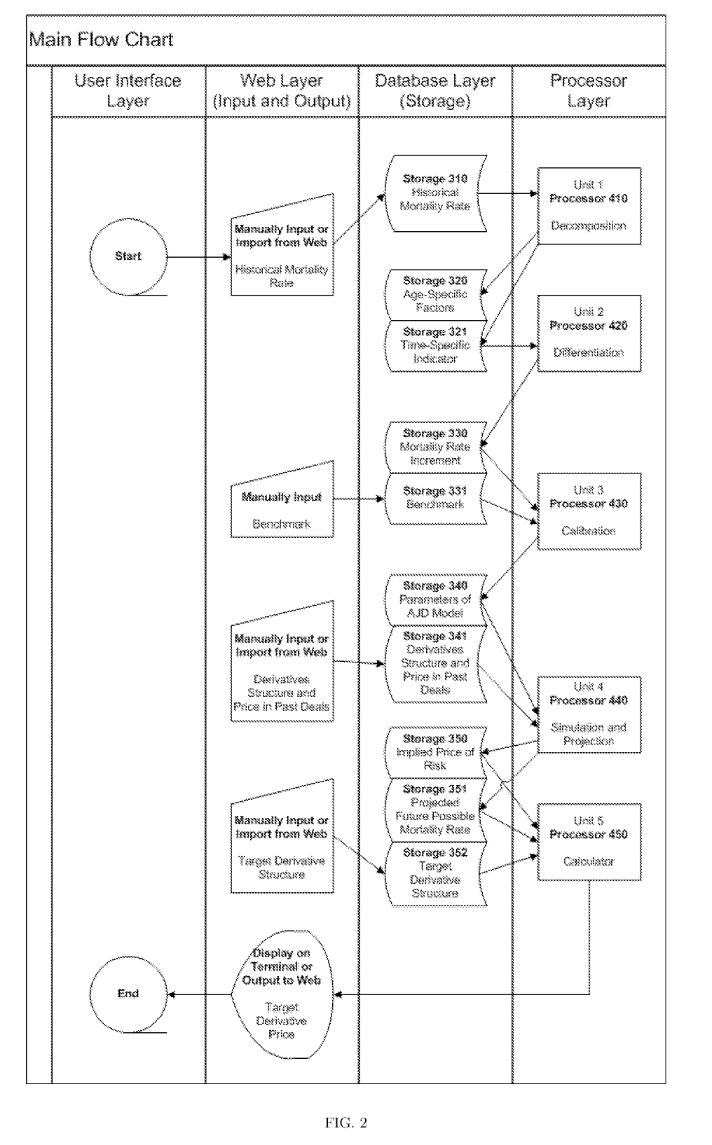

FIG. 2 depicts the main flow chart of the AJD computer-implemented method and computerized system, in corresponding to the components in FIG. 1, which is also composed by 4 layers: User Interface Layer, Web Layer (Input and Output), Database Layer (Storage) and Processor Layer. The Processor Layer includes 5 function units: 1. Decomposition Unit. Input the raw historical mortality rate, and output the age-specific factors and time-specific indicator which indicates the mortality trend, 2. Differentiation Unit. Input the mortality trend indicator, and output the increment of the mortality trend among time scale, 3. Calibration Unit. Input the increment of the mortality trend, and output the calibrated AJD model parameters {λ, p; η₁; η₂; α, σ}. 4. Simulation and Projection Unit. Input the calibrated AJD model parameters {λ, p; η₁; η₂; α, σ} and the actual longevity/mortality derivatives price data and output the implied market prices of risk, 5. Calculator Unit. Input the calibrated AJD model parameters {λ, p; η₁; η₂; α, σ}, implied prices of risk and target longevity/mortality derivatives structure, and output the target longevity/mortality derivatives prices.

Following the order of the flow chart, historical mortality rate is inputted manually or imported from web to the Storage 310. The historical mortality rate data is imported from Storage 310 to the Processor 410 (Unit 1), which decomposes mortality rate into age-specific factors and time-specific indicator, and exports them separately to Storage 320 and Storage 321. The time-specific indicator is imported from Storage 321 to Processor 420 (Unit 2), which differentiates the indicator and exports the mortality rate increment to Storage 330. Benchmark is manually inputted to Storage 331. The mortality rate increment in Storage 330 and the benchmark in Storage 331 are imported to Processor 430 (Unit 3), which executes the AJD model calibration with the mortality rate increment and benchmark, then exports the parameters of AJD model to Storage 340. Longevity or Mortality derivatives structure and price of past deals are manually inputted or imported from web to the Storage 341. The data in Storage 340 and Storage 341 is imported to Processor 440 (Unit 4), which executes simulation and projection, then exports the implied price of risk to Storage 350 and future possible mortality rate to Storage 351. Target longevity or mortality structure is manually inputted or imported from web to Storage 352. The data in Storage 350, Storage 351 and Storage 352 is imported to Processor 450 (Unit 5), which executes the calculation procedure to generate price for longevity bond, mortality bond, mortality swap, q-forward and other structured derivatives. The Processor 450 exports the derivatives prices to screen, printer, terminal or other devices.

While specific embodiments will be described below with reference to particular circuit or logic configurations, those of skill in the art will realize that embodiments of the present invention may advantageously be implemented with other substantially equivalent configurations.

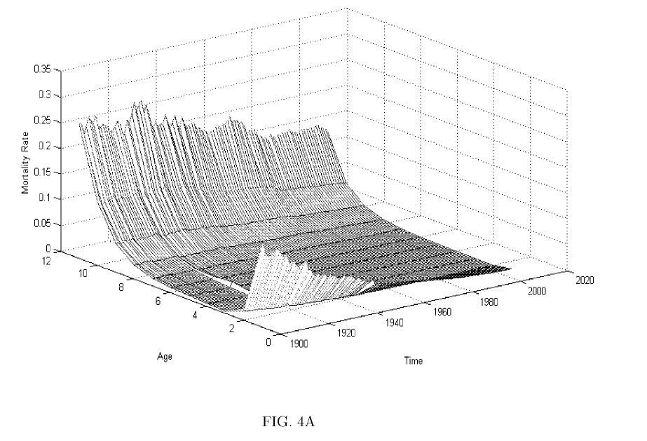

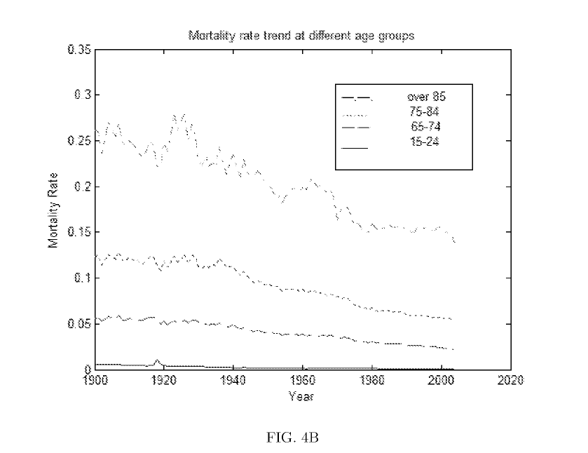

The detail of the 5 Units procedures are explained with the sample of U.S. historical mortality rate 1900-2004. The historical mortality rate data comes from HIST290 National Center for Health Statistics. It lists death rates per 100,000 populations for selected causes of death. Death rates are tabulated for age groups (<1), (1-4), (5-14), (15-24), then 10 years per group to (75-84) and (>85), including both sex and race categories. Selected causes for death include major conditions such as heart disease, cancer, and stroke. FIG. 4A shows the 3-D surface of the mortality rate for different age groups and different years. FIG. 4B shows the comparison of the mortality rate for several sample age groups, including relatively older groups and younger groups.

FIG. 4A and FIG. 4B show the two properties of the mortality rate trend. 1. In FIG. 4A, the downward trend indicates that the mortality rate changes to a decreasing trend from 1900-2004. For example, in the over 85 group, the mortality rate decreases from 0.26 to 0.14, while in the 15-24 young age group, the mortality rate decreases from 0.006 to 0.0008. The decreasing trend shows the improvement of the life length, or longevity in all age groups. 2. In FIG. 4B, the change of the mortality rate in the older age groups is more significant with a steeper downward trend than in that of the younger age groups. For example, the mortality rate decreases 0.12 in the older age group, over 85. During the same time period, the mortality rate decreases only 0.0052 in the younger age group, 15-24. The comparison of the trend steep shows that the improvement of the longevity of the older-aged population is more significant than that of the younger-aged population.

Unit 1, Decomposition Unit.

The basic requirement of the mortality model is to capturing the two features in FIG. 4A and FIG. 4B. Various mortality rate models have been provided by previous research. The majority of models are based on the Lee-Carter framework. In the Lee-Carter framework, the mortality rate μ_{x,t} on different age x and time t is decomposed into age-specific parameters aₓ, bₓ and a time-specific indicator kₜ.

ln(μ_{x,t})=aₓ+bₓkₜ+e_{x,t} (1)

μ_{x,t}=exp(aₓ+bₓkₜ+e_{x,t}) (2)

where aₓ represents the age groups shift effect, and e^{a}^{ₓ} is the general shape across the age of the mortality schedule. bₓ represents the age groups reaction effect to mortality indicator kₜ. In other words, bₓ profile describes which mortality rates decline rapidly and which mortality rates decline slowly in respond to changes in kₜ. And e_{x,t} captures the age groups residual effect not reflected in the model. Lee-Carter framework suggests a two-stage procedure Single Value Decomposition (SVD) which uses historical data of μ_{x,t} to estimate the age-specific parameters aₓ, bₓ, and generate the time-specific indicator kₜ time series.

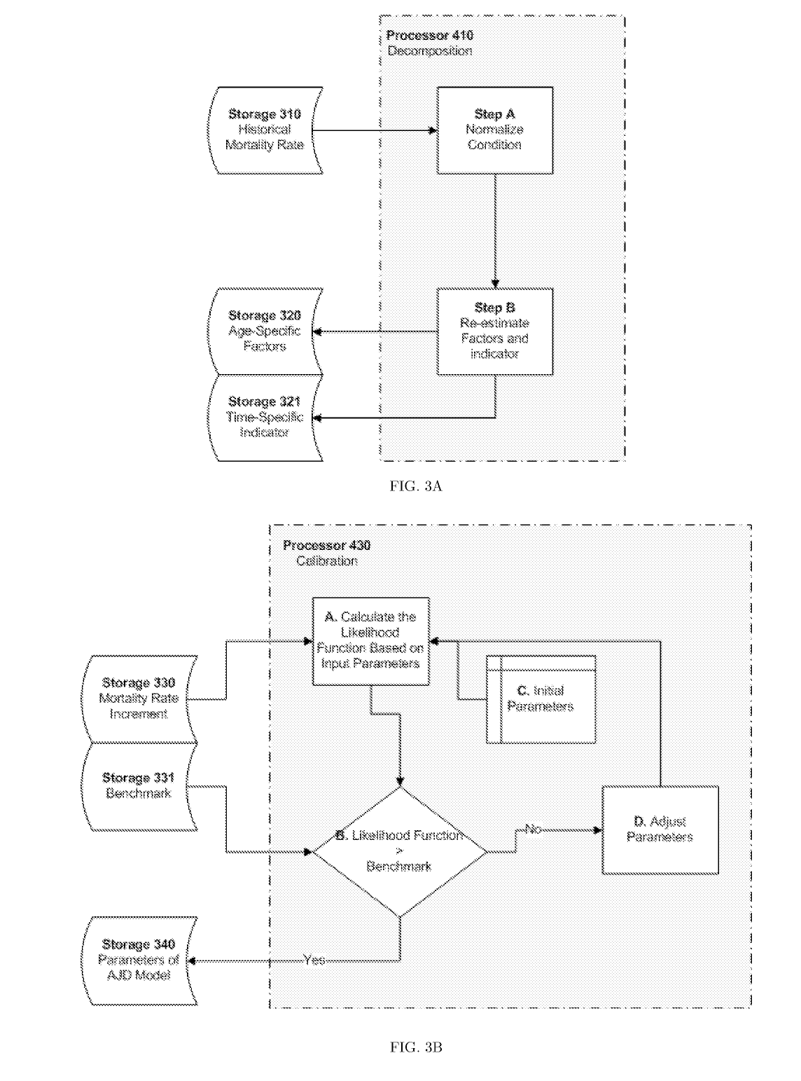

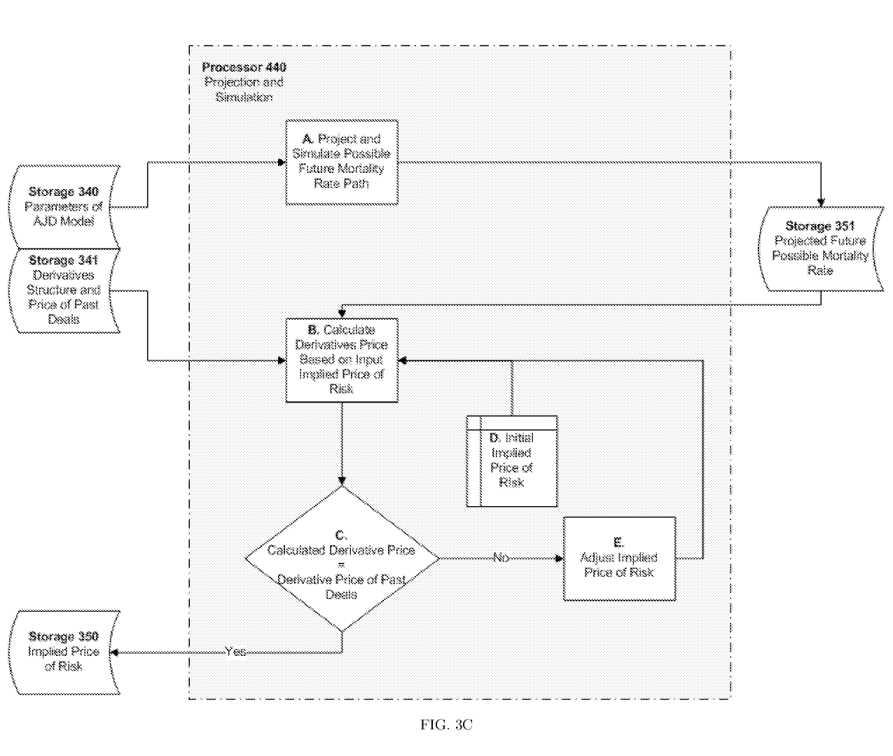

In FIG. 3A, the historical mortality rate is imported in Step A (Normalize Condition) of Processor 410 in Decomposition Unit.

Step A normalizes the condition and sets kₜ sum to 0 and bₓ sum to 1. Then aₓ must equal the average over time of ln(μ_{x,t}).

$${a}_{x} = \frac{1}{T} {\sum }_{t = 1}^{T} ln ( {μ}_{x , t} ) \qquad ( 3 )$$

Furthermore, kₜ must (almost) equal the sum over age of (ln(μ_{x,t})−aₓ), since the sum of the bₓ has been chosen to unity. This is not an exact relation, however, since the error terms will not in general sum to 0 for a given age. Then, each bₓ can be found by regression (ln(μ_{x,t})−aₓ) on kₜ separately for each age group x, without a constant term.

In FIG. 3A, Step B (Re-estimate Factors and Indicator) of Processor 410 is following Step A in the procedure of Decomposition Unit:

Step B re-estimates indicator kₜ iteratively, given the estimation of aₓ and bₓ in Step A, hence enables the actual sum of death at time t (left-hand side) equals the implied sum of deaths at time t (right-hand side).

$${D}_{t} = {\sum }_{x} ( {P}_{x , t} exp ( {a}_{x} + {b}_{x} {k}_{t} ) ) \qquad ( 4 )$$

where Dₜ is the actual sum of deaths at time t, and P_{x,t} is the population in age group x at time t.

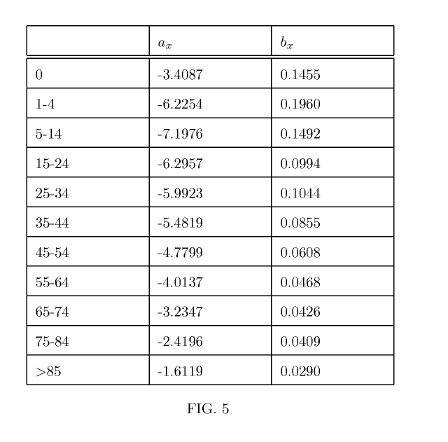

Processor 410 implements the SVD two-stage decomposition procedure with data from U.S. historical mortality rates over 1900-2004, the fitted age-specific factor aₓ, bₓ are referred to FIG. 5 and time-specific indicator (or mortality trend) kₜ is referred to FIG. 6. The decreasing trend of mortality indicator kₜ shows the improvement of mortality along the time as described. FIG. 6 also shows the big jump in 1918 which is caused by flu and other asymmetric jumps around 1920, 1943, etc.

First, the AJD model engages the stochastic process to describe the kₜ time series, which has proved to be better than the model without stochastic process. Second, shown in FIG. 6, since kₜ includes both positive and negative values, the Brownian motion, which will generate negative value from the positive starting value, does fit the kₜ time series. Third, FIG. 6 shows that the jump is transient, not permanent. For example, the sudden increase of mortality rate in 1918, caused by the flu, falls back to the normal condition in the second year.

Beyond the three points on the model specification listed above, the asymmetric jump phenomenon needs to be considered. In FIG. 6, the positive jumps (the suddenly remarkable increase in the time-series indicator trend) is with large magnitude and small frequency, while the negative jumps (the suddenly remarkable decrease in the time-series indicator trend) are of small scale and large frequency. Hence, the model that involves jump process with normal magnitude does not capture the asymmetric jump phenomenon. From the biological and demographic perspective, the positive jumps (mortality jumps) can be explained by sudden catastrophic reasons (e.g., earthquakes, hurricanes) or crucial diseases, such as the extreme positive jump caused by flu in 1918. The negative jumps (longevity jumps) are associated with multiple biological and health improvement reasons. The improvement of mortality due to health or biological reasons is moderate and does not show dramatic effect. As a result, the scale of jumps is not symmetric and hence cannot be characterized by normal distribution.

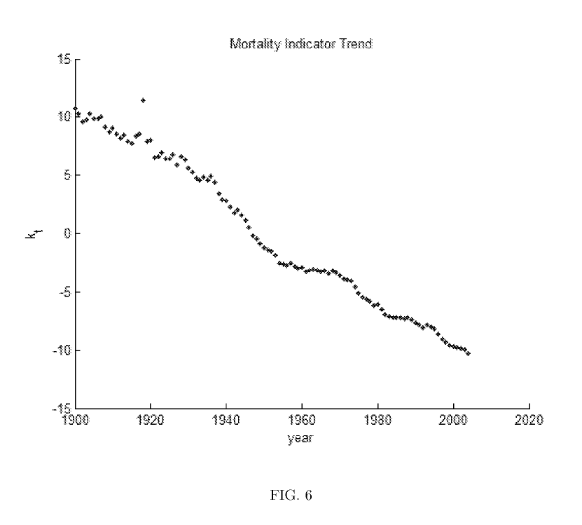

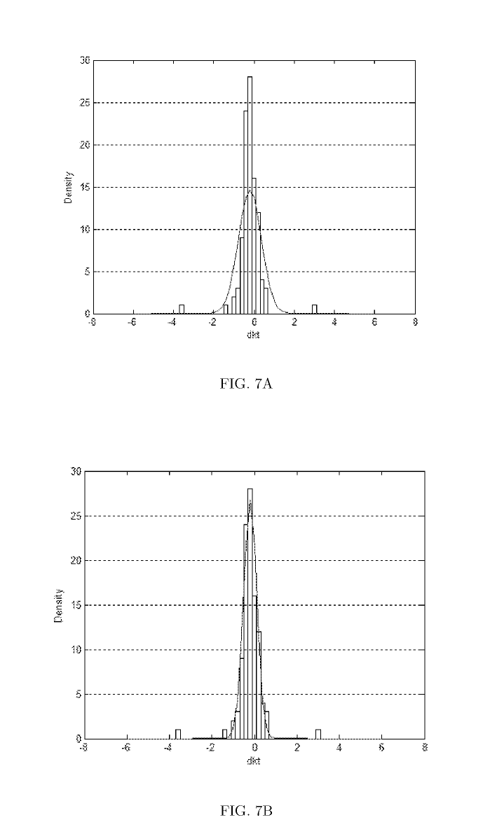

The descriptive statistics of Δkₜ=kₜ₊₁−kₜ shows asymmetric leptokurtic features. The skewness of dkₜ equals to −0.451. In other words, dkₜ distribution is skewed to the left, and has a higher peak and two heavier tails than those of a normal distribution, which is shown in FIG. 7A. In FIG. 7A, the histogram represents the distribution of actual Δkₜ, which can not be described by normal distribution. FIG. 7A illustrates that the Brownian motion process can not fit time-specific indicator kₜ time series appropriately.

To incorporate the leptokurtic feature of the Δkₜ distribution, the invention implements a double exponential jump-diffusion model capturing both the positive jumps and negative jumps of the kₜ process. The AJD model has a concise specification and a easy approach for calibration. Even more the AJD model has a closed-form solution for the forecast of the future mortality rate, which facilitates the mortality derivative pricing.

Unit 2, Differentiation Unit.

The computer-implemented model specification and the differentiation rules are executed by Processor 420, shown in FIG. 2.

To capture the features of the mortality indicator kₜ, and to account for the tractability and calibration of the model, we set the model specification to describe the characteristic Δkₜ in the approximate continuous-time model of dkₜ as the followings. The dynamics of the mortality indicator trend kₜ are:

$${dk}_{t} = α dt + σ d {W}_{t} + d ( {\sum }_{i = 1}^{N ( t )} ( {V}_{i} - 1 ) ) \qquad ( 5 )$$

where Wₜ is a standard Brownian motion. N(t) is a Poisson process with rate λ, and λ describes the frequency of the jump. The larger the λ, the more times that mortality trend indicator occurs in a jump, and Vᵢ is a sequence of independent identically distributed (i.i.d) nonnegative random variables, s.t. Y=log(V) has an asymmetric double exponential distribution with the density,

ƒ_{Y}(y)=pη₁e^{-η}^{₁}^{y} [symbol] +qη₂e^{η}^{₂}^{y}1_{{y<0}},

η₁,η₂0, p,q [symbol] 0, p+q=1. (6)

The p, q represent, respectively, the proportion of occurrence of positive jumps (the suddenly remarkable increase in the mortality indicator trend) and negative jumps (the suddenly remarkable decrease in the mortality indicator trend) among all jumps. So, pλ is the frequency of positive jumps and qλ is the frequency of negative jumps. η₁ and η₂ describe the positive jump scale and the negative jump scale separately. The larger the η₁ (or η₂), the smaller the positive (or negative) jump scale. In this way, the positive jumps and negative jumps are captured by similar distributions with different parameters, which matches the asymmetric historical trend of kₜ and the leptokurtic feature of dkₜ

Considering the risk neutral measure, then (5) becomes

$$\begin{matrix}{dk}_{t} = ( {α}^{*} - {λ}^{*} {γ}^{*} ) dt + σ d {W}^{*} + d ( {\sum }_{i = 1}^{{N}^{*} ( t )} ( {V}_{i}^{*} - 1 ) ) & ( 7 ) \\ {γ}^{*} = {E}^{*} [ {V}^{*} ] - 1 = \frac{p {η}_{1}^{*}}{{η}_{1}^{*} - 1} + \frac{q {η}_{2}^{*}}{{η}_{2}^{*} + 1} - 1 & ( 8 )\end{matrix}$$

Integrate (7)

$${k}_{s} = {k}_{0} + ( {α}^{*} - \frac{1}{2} {σ}^{2} - {λ}^{*} {γ}^{*} ) s + σ {W}_{s}^{*} + {\sum }_{i = 1}^{{N}^{*} ( s )} {Y}_{i}^{*} \qquad ( 9 )$$

According to the characteristic function

$$\begin{matrix} {E}^{*} [ {e}^{θ ( k ( s ) - {k}_{0} )} ] = exp [ G ( θ ) s ] or \\ {E}^{*} [ {e}^{θ k ( s )} ] = exp ( θ {k}_{0} ) exp [ G ( θ ) s ] \\ where & ( 10 ) \\ G ( θ ) = θ ( {α}^{*} - \frac{1}{2} {σ}^{2} - {λ}^{*} {γ}^{*} ) + \frac{1}{2} {θ}^{2} {σ}^{2} + {λ}^{*} ( \frac{p {η}_{1}^{*}}{{η}_{1}^{*} - θ} + \frac{q {η}_{2}^{*}}{{η}_{2}^{*} + θ} - 1 ) & ( 11 )\end{matrix}$$

Using bₓ for θ in (10), the closed-form expression for the expected future mortality rate μ_{x,t} is derived as

$$\begin{matrix}{E}^{*} [ {μ}_{x , t} ] = exp ( {a}_{x} ) \times {E}^{*} [ exp ( {b}_{x} {k}_{t} ) ] \\ = exp ( \begin{matrix}{a}_{x} + {b}_{x} {k}_{0} + {b}_{x} t ( {α}^{*} - \frac{1}{2} {σ}^{2} - {λ}^{*} {γ}^{*} ) + \\ \frac{1}{2} {b}_{x}^{2} {σ}^{2} t + {λ}^{*} t ( \frac{{p}^{*} {η}_{1}^{*}}{{η}_{1}^{*} - {b}_{x}} + \frac{{q }^{*} {η}_{2}^{*}}{{η}_{2}^{*} + {b}_{x}} - 1 )\end{matrix} )\end{matrix} \qquad ( 12 )$$

Unit 3, Calibration Unit.

In FIG. 3B, mortality rate increment in Storage 330 is imported to Step A in Processor 430 and the initial parameters {λ₀, p₀; η₀₁, η₀₂; α₀, σ₀} in Storage C of Processor 430 is imported to Step A. The algorithm for the calculation in Step A is as the following.

Let C={k₀, k₁, . . . , k_{T}} denote the historical mortality indicator trend, at equally-spaced times t=1, 2, . . . , T. The one period increment rᵢ=Δkᵢ=kᵢ−kᵢ₋₁ is i.i.d. As shown in Appendix 1, the unconditional density of one period increment ƒ(r) is:

$$f ( r ) = {e}^{- ( {λ}_{u} + {λ}_{d} )} {f}_{0 , 0} ( r ) + {e}^{- {λ}_{u}} {\sum }_{n = 1}^{∞} p ( n , {λ}_{d} ) {f}_{0 , n} ( r ) \\ + {e}^{- {λ}_{d}} {\sum }_{m = 1}^{∞} p ( m , {λ}_{u} ) {f}_{m , 0} ( r ) + {\sum }_{m = 1}^{∞} {\sum }_{n = 1}^{∞} p ( n , {λ}_{d} ) p ( m , {λ}_{u} ) {f}_{m , n} ( r ) \qquad \begin{matrix}\begin{matrix}\begin{matrix}( 13 ) \\ \end{matrix} \\ \end{matrix} \\ ( 14 )\end{matrix}$$

where p(n, λ_{d})=e^{-λ}^{_{d}}λ_{d}/n!, p(m, λᵤ)=e^{-λ}^{ᵤ}λᵤ/m! and ƒ_{m,n}(r) is the conditional density for one period increment, conditional on the given numbers of up and down jumps (m, n).

$$\begin{matrix} {f}_{0 , 0} ( r ) = \frac{1}{\sqrt{2 π} σ} {e}^{- \frac{1}{2 {σ}^{2}} {( r - μ + \frac{1}{2} {σ}^{2} )}^{2}} & ( 15 ) \\ {f}_{0 , n} ( r ) = \frac{{η}_{d}^{n}}{( n - 1 ) ! \sqrt{2 π} σ} {\int }_{- ∞}^{0} {( - x )}^{( n - 1 )} {e}^{( {η}_{d} x - \frac{1}{2 {σ}^{2}} {( r - x - μ + \frac{1}{2} {σ}^{2} )}^{2} )} d x & ( 16 ) \\ {f}_{m , 0} ( r ) = \frac{{η}_{u}^{m}}{( m - 1 ) ! \sqrt{2 π} σ} {\int }_{0}^{∞} {( x )}^{( m - 1 )} {e}^{( - {η}_{u} x - \frac{1}{2 {σ}^{2}} {( r - x - μ + \frac{1}{2} {σ}^{2} )}^{2} )} d x & ( 17 ) \\ {f}_{m , n} ( r ) = \frac{{η}_{u}^{m} {η}_{d}^{n}}{( m - 1 ) ! ( n - 1 ) ! \sqrt{2 π} σ} {\int }_{- ∞}^{∞} ( {\int }_{- ∞}^{0 t} {( - x )}^{n - 1} {( t - x )}^{m - 1} {e}^{( {η}_{u} + {η}_{d} ) x} d x ) \\ \times {e}^{- {η}_{u} t} {e}^{- \frac{1}{2 {σ}^{2}} {( r - x - μ + \frac{1}{2} {σ}^{2} )}^{2}} d t & \begin{matrix}\begin{matrix}\begin{matrix}( 18 ) \\ \end{matrix} \\ \end{matrix} \\ ( 19 )\end{matrix}\end{matrix}$$

The log-likelihood given T equally spaced increment observations is:

$$L ( C ; {λ}_{u} , {λ}_{d} ; {η}_{1} , {η}_{2} ; α , σ ) = {\sum }_{i = 1}^{T} ln ( f ( {r}_{i} ) )$$

where λ=λᵤ+λ_{d}, and

$$p = \frac{{λ}_{u}}{λ} .$$

The benchmark value in Storage 331 is imported to Step B in Processor 430 and the calculated likelihood function value of Step A is also imported to Step B. If the calculated likelihood function value is larger than the benchmark value, then the calibrated parameter {λ, p; η₁, η₂; α, σ} is exported to Storage 340. Otherwise, the adjusted parameters in Step D are imported to Step A and Processor 430 repeats the procedure.

After computation we get {λᵤ, λ_{d}; η₁, η₂; α, σ}={0.029,0.035,0.71,0.75,−0.20,0.31}, and {λ, p; η₁, η₂; α, σ}={0.064,0.45; 0.71,0.75,−0.20,0.31} and maximum likelihood value L=−49.95.

FIG. 7B shows how the fitness of AJD model to the actual increment of mortality rate dkₜ, by comparing the distribution of the AJD model calibrated by historical data and the actual distribution of dkₜ. Comparing FIG. 7B with FIG. 7A, The AJD model approximates the distribution of increment of mortality rate dkₜ much better than the commonly used Lee-carter Brownian Motion model. The mean of the distribution of AJD and the Brownian Motion is the same, (μ_{AJD}=μ_{BM}=−0.20), while the standard deviation of the distribution of AJD (σ_{AJD}=0.31<σ_{BM}=0.57) is significant less than the Brownian Motion. It is exactly the reason that the AJD model is more appropriate to characterize the actual distribution, which is shown in the comparison of the FIG. 7A and FIG. 7B.

Next, the AJD model is compared with both Lee-carter Brownian motion model and the normal jump diffusion model. For model selection, the widely used Bayesian information criterion (BIC) is adopted. Unlike the significance test, BIC allows comparison of more than two models at the same time and does not require that the alternatives to be nested. BIC is a “conservative” criterion since it heavily penalizes over-parameterization.

Suppose the kth model Mₖ, has parameter vector θₖ, where θₖ consists of nₖ independent parameters to be estimated. Denote θ′ₖ as the MLE of θₖ Then, BIC for Model Mₖ is defined as:

BICₖ=−2 ln ƒ(C|θ′ₖ,Mₖ)+nₖ ln(m), (20)

Where m is the number of observations in data set C and ƒ(C|θ′ₖ, Mₖ) is the maximized likelihood function. Clearly the best “fit” model is one with the smallest BIC. FIG. 8 illustrates the advantage of the model selection of the invention.

Unit 4, Simulation and Projection Unit.

In FIG. 3C, Longevity or Mortality derivatives structure and price of past actual deals are imported to the Step B of Processor 440, Projection and Simulation Unit. Take Swiss Re Mortality Catastrophe Bond as an example to explain detailly how the Processor 440 works.

The price of the bond is: the coupon rate of 135 basis points plus the LIBOR. The structure of the bond is: a maturity of three years, a principal of $400 m. The mortality index, Mₜ, is a weighted average of mortality rates over five countries, males and females, and a range of ages. The principal is repayable in full only if the mortality index does not exceed 1.3 times the 2002 base level during any year of the bond's life, and was otherwise dependent on the realized values of the mortality index. The precise payment schedules are given by the following ƒₜ(•) functions:

$${f}_{t} ( \cdot ) = \{ \begin{matrix}LIBOR + spread & t = 1 , … , T - 1 \\ LIBOR + spread + max \{ 0 , 100 \% - {\sum }_{t} {L}_{t} \} & t = T ,\end{matrix} \} \\ {L}_{t} = \{ \begin{matrix}0 \% & \\ [ ( {M}_{t} - 1.3 {M}_{0} ) / ( 0.2 {M}_{0} ) ] \times 100 \% & if \\ 100 \% & \end{matrix} \{ \begin{matrix}{M}_{t} < 1.3 {M}_{0} \\ 1.3 {M}_{0} \leq {M}_{t} \leq 1.5 {M}_{0} for all t \\ 1.5 {M}_{0} < {M}_{t}\end{matrix} \qquad ( 21 )$$

The parameters of AJD model in Storage 340, {λ, p; η₁, η₂; α, σ}, are imported to the Step A of Processor 440. The algorithms of the two approaches to calculating the implied market price of risk is as the following.

1. Wang Transform:

There is no efficiently traded underlying mortality index to create a replicating portfolio for pricing. In such an incomplete market situation, Wang's distorted method transforms the underlying distribution to enable the derivatives price to exactly equal the discounted expected values. Wang's transform is economically intuitive because it is in accordance with the capital asset pricing model (CAPM) for underlying assets and the Black-Scholes formula for options.

Given a random payment X and cumulative density function F_{X}(x) under the measure P, then the Wang transform is defined as that the “distorted” or transformed distribution F_{X}*(x) is determined by the market price of risk δ according to the equation

F_{X}*(x)=Φ[Φ⁻¹(F_{X}(x))−δ] (22)

where Φ(x) is the standard normal cdf, and δ is the implied market price of risk which reflects the level of market systematic unhedgeable risk. After the transform, the fair price of X, or the expectation of X under F_{X}*(x) should be the discounted expected value using the transformed distribution.

In this invention, Swiss Re mortality catastrophe bond is used as the known price for calibration, in order to price the q-forward as an implementation of our AJD model. The set of implied market prices of risk δ={δ₁, δ₂, δ₃} is in correspondence to the Brownian motion, the positive jump severity and the negative jump severity, {α*, η₁*, η₂*}. Since the mortality derivatives are priced in the incomplete market, the value of δ or the risk-neutral measure Q is not unique.

Following is the traditional procedure for calculating the market price of risk:

Step 1. Based on the known 2003 mortality indicator imported from Storage 321 in FIG. 2, Step A in Processor 440 of FIG. 3C simulates 10,000 times the future mortality indicator trend k(t) for 2004-2006, using the AJD model (5) with the calibrated parameter set {λ, p; η₁, η₂; α, σ}={0.064,0.45; 0.71,0.75,−0.20,0.31} imported from Storage 340, and the initial assumed set δ={δ₁, δ₂, δ₃}={0, 0, 0} imported from Storage D in Processor 440, with Wang transform function.

Step 2. Step B in Processor 440 calculates the mortality rate μ_{x,t} by the formula (2) and calculates the average μₜ based on year 2000 standard population and corresponding weights.

Step 3. Step B in Processor 440 calculates expected value of the principal payment in every period T by the formula, E_{T}*[payment]=$400,000,000×[max(1−Σₜ₌₂₀₀₄²⁰⁰⁶Lₜ, 0)], Lₜ follows (21). The coupon payment in every period is calculated based on the par spread plus 1.35% risk premium in Storage 341.

Step 4. Step E in Processor 440 adjusts the market price of risk set δ and exports to Step B. Repeat step 1-step 3 except using new δ replacing the initial assumed set δ={δ₁, δ₂, δ₃}={0, 0, 0} in Storage D, until the discounted expected value of the coupon payment in 2004-2006 plus the principal payment in 2006 equal the face value of the mortality bond $400,000,000 in Step C, then exports implied price of risk {δ₁, δ₂, δ₃} to Storage 350.

2. Risk-Neutral Pricing

Another approach is the risk-neutral method. The method is derived from the financial economic theory that posits even in an incomplete market. If the overall market is no arbitrage, there exists at least one risk-neutral measure Q for calculating fair prices. The more sophisticated assumption about the dynamics of the market price is pointless, since the available issued longevity or mortality derivatives are rare and the data are limited. However, as the mortality linked securities liquid market develops, the more accurate market price of risk can be calculated based on the adequacy of deal and data.

The risk neutral pricing differs from Wang transform only in that we assume the linear transform instead of the distorted transform function. Assume the market price of risk set ζ={ζ₁, ζ₂, ζ₃}. α*=α+ζ₁; η₁*=η₁+ζ₂; η₂*=η₂+ζ₃.

The below procedure is similar to the Wang Transform approach:

Step 1. Based on the known 2003 mortality indicator imported from Storage 321 in FIG. 2, Step A in Processor 440 of FIG. 3C simulates 10,000 times the future mortality indicator trend k(t) for 2004-2006, using the AJD model (5) with the calibrated parameter set {λ, p; η₁, η₂; α, σ}={0.064,0.45; 0.71,0.75,−0.20,0.31} imported from Storage 340, and the initial assumed set ζ={ζ₁, ζ₂, ζ₃}={0, 0, 0} imported from Storage D in Processor 440, with the risk-neutral transform function.

Step 2. Step B in Processor 440 calculates the mortality rate μ_{x,t} by the formula (2) and calculates the average μₜ based on year 2000 standard population and corresponding weights.

Step 3. Step B in Processor 440 calculates expected value of the principal payment in every period T by the formula, E_{T}*[payment]=$400,000,000×[max(1−Σₜ₌₂₀₀₄²⁰⁰⁶Lₜ, 0)], Lₜ follows (21). The coupon payment in every period is calculated based on the par spread plus 1.35% risk premium in Storage 341.

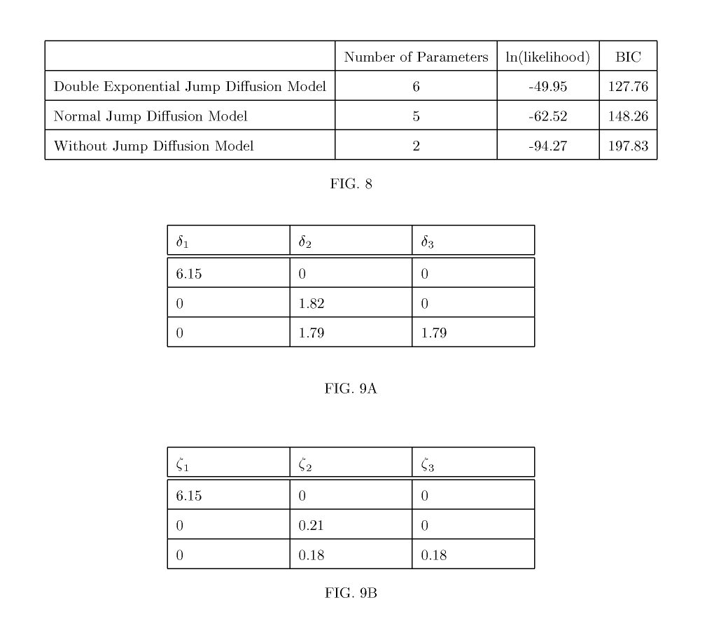

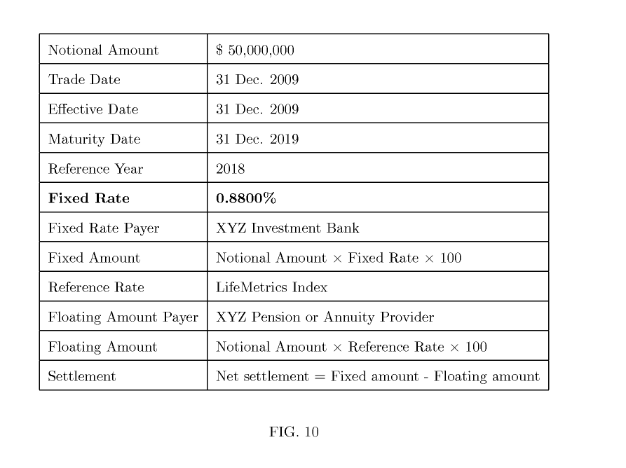

Step 4. Step E in Processor 440 adjusts the market price of risk set ζ and exports to Step B. Repeat step 1-step 3 except using new ζ replacing the initial assumed set ζ={ζ₁, ζ₂, ζ₃}={0, 0, 0} in Storage D, until the discounted expected value of the coupon payment in 2004-2006 plus the principal payment in 2006 equal the face value of the mortality bond $400,000,000 in Step C, then exports implied price of risk {ζ₁, ζ₂, ζ₃} to Storage 350, which is shown in FIG. 9B

Unit 5, Calculator Unit.

In FIG. 2, the target derivative structure is manually inputted or imported from the web to Storage 352. The invention takes the derivative q-forwards as example to explain the pricing engine in the procedure of Calculator Unit. The derivative structure of q-forwards is illustrated in FIG. 10.

q-forwards: q-forwards are proposed by JP-Morgan as a simple capital market instruments for transferring longevity risk and mortality risk. q-forwards enable pension, annuity providers to hedge against increasing life expectancy of plan members and life insurers to protect themselves against significant increases in the mortality of policyholders. Similar as other forwards, q-forwards are derivatives involving the exchange of the realized mortality of a population at some future date, in return for a fixed mortality rate agreed at inception. q-forwards form the basic building blocks from which many other more complex derivatives can be constructed. q-forwards provide a type of standardized contracts which help to create a liquid market. A set of q-forwards that settle based on the LifeMetrics Index could fulfill this role. Since the investors require a risk premium to take on longevity risk, the mortality forward rates at which q-forwards transact will be below the expected, or “best estimate” mortality rates.

A q-forward contract to hedge the mortality risk of a life insurer is that a life insurer pays fixed mortality rate to JP Morgan and JP Morgan pays realized mortality rate to the life insurer. A q-forward contract to hedge the mortality risk of a pension fund is that a pension fund pays realized mortality rate to JP Morgan and JP Morgan pays the fixed rate to the pension fund. In this way, the pension fund who longs the longevity risk transfer the risk to the life insurer who shorts the longevity risk.

In FIG. 2, the implied prices of risk in Storage 350, the projected future possible mortality rate in Storage 351 and the target derivative q-forwards structure are imported to Processor 450, which produces the target derivative q-forwards price and exports it to the terminal or printer. In q-forwards case, the price is the Fixed Rate on the contract of FIG. 10.

Longevity Bonds: This The EIB/BNP Paribas Longevity Bond is an example of the longevity bond. The bond was announced by the European Investment Bank (EIB) in November 2004. It had an initial value of £540 m, an initial coupon of £50 m, and a maturity of 25 years. The structure/manager was BNP Paribas. The longevity risk was to be reinsured through the Bermuda-based reinsurer Partner Re which contracted to make annual floating rate payments (equal to £50 m×Sₜ) to the EIB based on the realized mortality experience of the population of English and Welsh males aged 65 in 2003 (published by the UK Office for National Statistics) and receive from the EIB annual fixed payments based on a set of mortality forecasts for this cohort. The mortality forecasts were based on the UK Government Actuary's Department's 2002-based central projections of mortality, adjusted for Partner Re's own internal revisions to these forecasts. Since the EIB also wished to pay a floating rate in euros, this arrangement was then supplemented by a cross currency (i.e., fixedsterling-for-floating-euro) interest-rate swap between the EIB and BNP Paribas.

The main characteristics of this bond are: The bond was designed to be a hedge to the holder. The issuer gains if Sₜ is lower than anticipated (and conversely, the buyer gains if Sₜ is higher than anticipated). Thus, the bond is a hedge against a portfolio dominated by annuity (rather than life insurance/reinsurance) policies. The bond is a long-term bond designed to protect the holder against any unanticipated improvement in mortality up to the maturity date of the bond. Sₜ involves a single national survivor index. The bond is an annuity (or amortizing) bond and all coupon payments are at risk from longevity shocks. More precisely, the payment schedules are directly proportional to the survivor indexes: ƒₜ(Sₜ)=£50 m×Sₜ for t=1, 2, . . . , T; T=25.

Mortality Bond: Besides the Swiss Re Mortality Catastrophe Bond listed in [0075]. In 2006, Scottish Re raised USD 155 million via Tartan Capital in 3-year notes. Osiris Capital was arranged by Swiss Re, but on behalf of the AXA Group, which was the ultimate buyer of protection in 2006. The outstanding volume was EUR 345 million and the maturity was 4 years.

The various functions disclosed herein may be described using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to non-volatile storage media in various forms (e.g., optical, magnetic or semiconductor storage media).

While particular elements, embodiments and applications of the present invention have been shown and described, it is understood that the invention is not limited thereto since modifications may be made by those skilled in the art, particularly in light of the foregoing teaching. It is therefore contemplated by the appended claims to cover such modifications and incorporate those features which come within the spirit and scope of the invention.

What is claimed is:

1. A computer-implemented method, for assessing and quantifying a longevity risk through capturing a mortality rate with an asymmetric jump diffusion model, and pricing a plurality of longevity derivatives and a plurality of mortality derivatives, comprising: decomposing a mortality rate trend into a plurality of age-specific factors and a mortality indicator; capturing the mortality indicator trend by the asymmetric jump diffusion model; calibrating the asymmetric jump diffusion model parameters by a maximum likelihood estimation method with a closed-form density function; projecting and forecasting a mortality indicator trend by a Monte-Carlo simulation program, and calculating an implied market price of risk with a structure and a price of an actual longevity derivative; pricing a plurality of longevity risk derivatives and a plurality of morality risk derivatives with a plurality of projected future mortality rates, using the implied market price of risk.

2. The computer-implemented method of claim 1, wherein the asymmetric jump diffusion (AJD) model method is comprising: a baseline Brownian motion stochastic process; a compound Poisson double-exponential jump diffusion process.

3. The computer-implemented method of claim 1, wherein a closed-form formula is provided to calculate an expectation value of the projected future mortality rates.

4. The computer-implemented method of claim 1, wherein the asymmetric jump diffusion (AJD) model is implemented to simulate and generate a numerical solution for the implied price of risk.

5. The computer-implemented method of claim 1, further comprising a pricing engine to pricing a plurality of longevity derivatives and a plurality of mortality derivatives including a longevity bond, a mortality bond, a q-forward, and other structured products.

6. A computerized system, for assessing and quantifying a longevity risk through capturing a mortality rate with an asymmetric jump diffusion model, and pricing a plurality of longevity derivatives and a plurality of morality derivatives, via processors executing a plurality of programmed instructions, comprising: means for decomposing a mortality rate trend into a plurality of age-specific factors and a mortality indicator; means for capturing the mortality indicator trend by the asymmetric jump diffusion model; means for calibrating the asymmetric jump diffusion model parameters by a maximum likelihood estimation method with a closed-form density function; means for projecting and forecasting a future mortality indicator trend by a Monte-Carlo simulation program, and calculating an implied market price of risk with a structure and a price of an actual longevity derivative; means for pricing a plurality of longevity risk derivatives and a plurality of mortality risk derivatives with a plurality of projected future mortality rates, using the implied market price of risk.

7. The computerized system of claim 6, wherein the computer readable code for the asymmetric jump diffusion (AJD) model system is comprising: a baseline Brownian motion stochastic process; a compound Poisson double-exponential jump diffusion process.

8. The computerized system of claim 6, wherein a programmed closed-form formula is provided to calculate an expectation value of the projected future mortality rates.

9. The computerized system of claim 6, wherein a computer readable code is implemented for the asymmetric jump diffusion (AJD) model to simulate and generate a numerical solution for the implied price of risk.

10. The computerized system of claim 6, further comprising a pricing engine based on a computer readable medium to pricing a plurality of longevity derivatives and a plurality of mortality derivatives including a longevity bond, a mortality bond, a forward, and other structured products.
